(19) United States
(12) Patent Application Publication
(10) Pub. No.: US 2010/0169218 A1
(43) Pub. Date: Jul. 1, 2010

(54) SECURE AUTHENTICATION OF LECTRONIC PRESCRIPTIONS

(75) Inventors: Changjie Wang, Shanghai (CN); Fulong Ma, Shanghai (CN)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., Eindhoven (NL)

(21) Appl. No.: 12/666,403

(22) PCT Filed: Jun. 26, 2008
(86) PCT No.: PCT/IB08/52569

§ 371 Date: Dec. 23, 2009

(30) Foreign Application Priority Data
Jun. 27, 2007 (CN) 200710109502.8

(51) Int. Cl. G06Q 50/00; H04L 9/32; G06Q 10/00

(52) U.S. Cl. 705/50; 713/175

(57) ABSTRACT

The invention relates to a system for authenticating electronic prescriptions, the system comprising an acquisition unit for acquiring an electronic prescription for authentication, the electronic prescription comprising a transaction number, a first pseudonym, and a signature of a first participant using a transaction pseudonym, the first pseudonym indicating the first participant's registration at a first privacy officer; a generation unit for generating the transaction pseudonym based on the first pseudonym, the transaction number and a registration key corresponding to the first pseudonym and being shared between the first participant and a second privacy officer; and a validation unit for verifying the first participant's registration at the second privacy officer and the authenticity of the signature based on the registration key and the transaction pseudonym. As the transaction pseudonym depends on registrations at two privacy officers and a transaction number for a real-time prescription, the participant's privacy can be well protected from each privacy officer.

### FIELD OF THE INVENTION

The invention relates to applied cryptography, particularly to a method of generating a transaction pseudonym used for secure authentication.

The invention further relates to a method and a system for secure authentication of an electronic prescription.

Furthermore, the invention relates to a computer program for implementing said secure authentication method on a computer.

### BACKGROUND OF THE INVENTION

The E-prescription system is a substitute for the traditional paper-based process of transferring a medical prescription from clinic to pharmacy. As one of the most important issues in an electronic prescription system, secure authentication for processing an electronic prescription has attracted much attention and interest among researchers and in industrial circles.

The state-of-the-art document “Anonymous E-Prescriptions” by G. Ateniese and B. Medeiros in Proc. ACM Workshop Privacy in the Electronic Society (WPES02), 2002 discloses an anonymous electronic prescription system, in which a doctor or a patient uses his identification to register at a privacy officer, who issues a unique pseudonym to the doctor or patient, and the doctor or patient uses his own pseudonym to sign up an electronic prescription on a diagnose basis and then has the electronic prescription authenticated by the privacy officer.

In the electronic prescription system, the privacy officer working as a third party is assumed to be fully trusted and the privacy protection of the doctor or patient entirely depends on the third party only. However, such an assumption is not always realistic, as it is always possible that the third party maybe corrupted or hacked, which may lead to infringement of the doctor or patient's privacy.

### OBJECT AND SUMMARY OF THE INVENTION

It is, inter alia, an object of the invention to provide a system for authenticating electronic prescriptions, which improves the privacy protection of the participant signing the electronic prescription.

To this end, the invention provides a system for authenticating electronic prescriptions, the system comprising an acquisition unit for acquiring an electronic prescription for authentication, the electronic prescription comprising a transaction number, a first pseudonym, and a signature of a first participant using a transaction pseudonym, the first pseudonym indicating the first participant's registration at a first privacy officer; a generation unit for generating the transaction pseudonym based on the first pseudonym, the transaction number and a registration key corresponding to the first pseudonym and being shared between the first participant and a second privacy officer; and a validation unit for verifying the first participant's registration at the second privacy officer and the authenticity of the signature on the basis of the registration key and the transaction pseudonym.

In an embodiment, the validation unit is further arranged to check the first participant's history record by linking all electronic prescriptions signed by the first participant to the first pseudonym.

It is a further object of the invention to provide a method of authenticating electronic prescriptions, which improves the privacy protection of the participant signing the electronic prescription.

To this end, the invention provides a method of authenticating electronic prescriptions, the method comprising the steps of: acquiring an electronic prescription for authentication, the electronic prescription comprising a transaction number, a first pseudonym indicating a first participant's registration at a first privacy officer, and a signature of the first participant using a transaction pseudonym; generating the transaction pseudonym based on the first pseudonym, the transaction number and a registration key corresponding to the first pseudonym and being shared between the first participant and a second privacy officer; and verifying the authenticity of the registration and signature of the first participant on the basis of the registration key and the transaction pseudonym.

In the authentication method and system according to the invention, the first participant uses a transaction pseudonym to sign the electronic prescription. As the transaction pseudonym is generated on the basis of a first pseudonym registered at a first privacy officer, a registration key shared between the second privacy officer and the first participant, and a transaction number randomly generated for a real-time prescription transaction, this enables the first participant to use a different transaction pseudonym for each electronic prescription and thus protects his privacy from the two privacy officers during each authentication transaction.

Although the transaction pseudonym is different for each electronic prescription signed by the first participant, the second privacy officer can still link all electronic prescriptions issued and signed by the first participant to a first pseudonym based on the unique mapping relationship between the first pseudonym and the registration key, and can thus easily check the first participant's history records.

It is another object of the invention to provide a method of generating pseudonyms for secure authentication, which improves the privacy protection of a participant during the transaction.

To this end, the invention provides a method of generating a transaction pseudonym for secure authentication, the method comprising the steps of: registering a participant at a first privacy officer so that the participant's identity can be uniquely defined and determined by a first pseudonym; registering the participant at a second privacy officer so that the participant's identity can be uniquely determined by mapping a registration key shared between the second privacy officer and the participant to the first pseudonym; and generating a transaction pseudonym for the participant on the basis of the first pseudonym, the registration key and a transaction number related to a transaction.

As the transaction pseudonym is generated in dependence upon registrations at two privacy officers and a transaction number, the participant's privacy is well protected from each privacy officer.

It will be evident to those skilled in the art that modifications and variants of the authentication system, the method, and/or the computer program product as herein described are possible on the basis of the present description.

### BRIEF DESCRIPTION OF THE DRAWINGS

The above and other objects and features of the present invention will become more apparent from the following detailed description with reference to the accompanying drawings, in which:

FIG. 1 is a flow chart showing an embodiment of a method of generating a transaction pseudonym according to the invention.

FIG. 2 schematically shows an embodiment of a method of authenticating electronic prescriptions according to the invention.

FIG. 3 is a block diagram showing an embodiment of an authentication system according to the invention.

FIG. 4 is a block diagram showing an electronic prescription processing system including an authentication system according to the invention.

In these Figures, identical parts are denoted by identical references.

### DESCRIPTION OF EMBODIMENTS

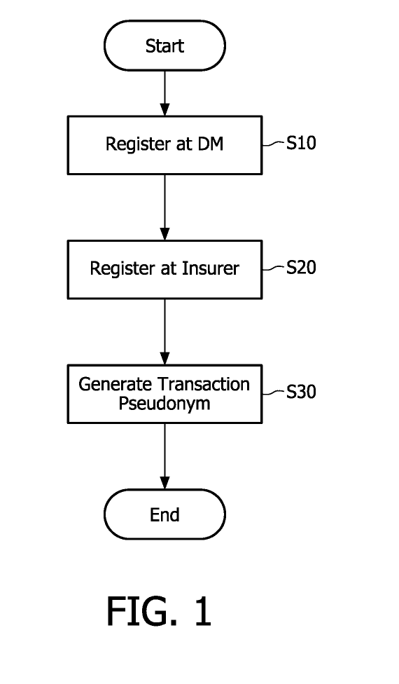

FIG. 1 is a flow chart showing an embodiment of a method for generating a transaction pseudonym according to the invention. First, a participant, e.g. a pseudonym user, registers at a first privacy officer, for example, a doctor manager (DM), so that the participant's identity can be uniquely defined and determined by a first pseudonym (S10), then the participant registers at a second privacy officer, for example, an insurer, so that the participant's identity can be uniquely determined by mapping a registration key, shared between the second privacy officer and the participant, to the first pseudonym (S20); and subsequently a transaction pseudonym is generated for the participant on the basis of the first pseudonym, the registration key and a transaction number linked to a transaction (S30).

In step S10 of the process of the method according to the invention, the first pseudonym is generated on the basis of the participant's public key and the first privacy officer's private key in accordance with the following equation:

Y_{Dr}=y_{Dr}^{x}^{_{DM}} mod p [1]

wherein Y^{Dr} is the first pseudonym, x_{DM} is the first privacy officer's private key, and Y_{Dr} and x_{Dr} are the participant's public key and private key, respectively, complying with:

y_{Dr}=g^{x}^{_{Dr}} mod p [2]

wherein p is a large prime number and g is a generator of the group of p with order q, the private key x_{Dr}ε{1, . . . , q−1}, and q is a large prime number complying with q/(p−1), e.g. q can be divided exactly by p−1. For details on how to generate the private and public key, reference is made to ElGamal, T. “A Public-key cryptosystem and a signature scheme based on discrete logarithms” in Advances in Cryptology—CRYPTO'84 Proceedings, Springer Verlag, pp. 10-18, 1985 (cited as Ref. 1 hereinafter). For simplicity, “mod p” will hereinafter be omitted in equations.

As a public key in a secure system is uniquely linked to a participant, for example, the participant's identification, the participant's identity can be uniquely defined and determined by the first pseudonym.

It is advantageous that the first pseudonym can be published on an electronic public board and is accessible by a third party.

In step S20, a registration key may be generated on the basis of registration or it may be provided for registration by the participant. The registration key will be shared only between the participant and the second privacy officer and is uniquely mapped to the first pseudonym as an indication of the participant's registration at the second privacy officer.

In step S30, when the participant engages in a transaction, a transaction pseudonym is generated in accordance with equation:

Ŷ_{DR}=(Y_{Dr})^{k}^{ᵢ} [3]

wherein Ŷ_{DR} is the transaction pseudonym, kᵢ is a transaction key defined as:

kᵢ=h(R_{Dr}⊕kᵢ₋₁),k₀=(R_{Dr}∥Y_{Dr}) [4]

wherein Ŷ_{DR} is the transaction pseudonym, i is the transaction number related to the electronic prescription, kᵢ is a transaction key as defined, and R_{Dr} is the registration key shared between the second privacy officer and the first participant, wherein h(•) is a cryptographic hash function, and k₀ is the concatenation of the registration key R_{Dr} and the first pseudonym Y_{Dr}.

When a participant uses a transaction pseudonym to sign up a transaction, the second privacy officer can authenticate the participant's identification and authenticity by retrieving the transaction pseudonym based on the first pseudonym, the registration key and a transaction number regarding a specific transaction. In detail, the second privacy officer can retrieve the transaction number i and the first pseudonym Y_{Dr} to calculate the transaction key kᵢ in accordance with a known function defined in Eq.[4], and then calculate the transaction pseudonym Ŷ_{DR} by using the transaction key kᵢ and the first pseudonym Y_{Dr} in accordance with Eq.[3]. Subsequently, the second privacy officer can use the transaction pseudonym to verify the participant's signature.

As the transaction pseudonym is generated on the basis of the first pseudonym, the registration key and the transaction number, the participant can use this transaction pseudonym for a specific transaction with privacy protected from both the first and the second privacy officer. Particularly, the second privacy officer can link all transactions signed by the participant to the same first pseudonym for checking the participant's history records, even when the participant uses a different transaction pseudonym for each transaction.

The method of generating a transaction pseudonym finds particular application in medical electronic prescription systems. In such systems, a few parties are necessarily involved when an electronic prescription is issued and authenticated: a prescription originator or writer, e.g. a medical facility, a doctor, physician or other healthcare professional, a hospital, etc., referred to as first participant or doctor for the purpose of a simple description; a doctor management authority functioning as an authority organization to certify a doctor's qualification of issuing such electronic prescriptions, referred to as first privacy officer or doctor manager; a prescription drug recipient or patient, referred to as second participant or patient for simple description; an insurer, insurance agency or the like to validate the electronic prescription, referred to as second privacy officer or insurer for simple description. Optionally, it may also involve a prescription drug provider, e.g. a pharmacy or the like, referred to as pharmacy, to fill out the electronic prescription and collect the corresponding amount due for payment from the insurer or the patient, if applicable.

The patient has probably signed an agreement regarding a certain health plan with the insurer, and the electronic prescription issued to the patient is expected to match the patient's health plan. All parties involved in the process are defined in accordance with their functions, easy understanding of the role of each party and no limitation to their physical meanings. For example, the doctor manager and the insurer holding the doctor and/or the patient's private information are referred to as first privacy officer and second privacy officer, respectively.

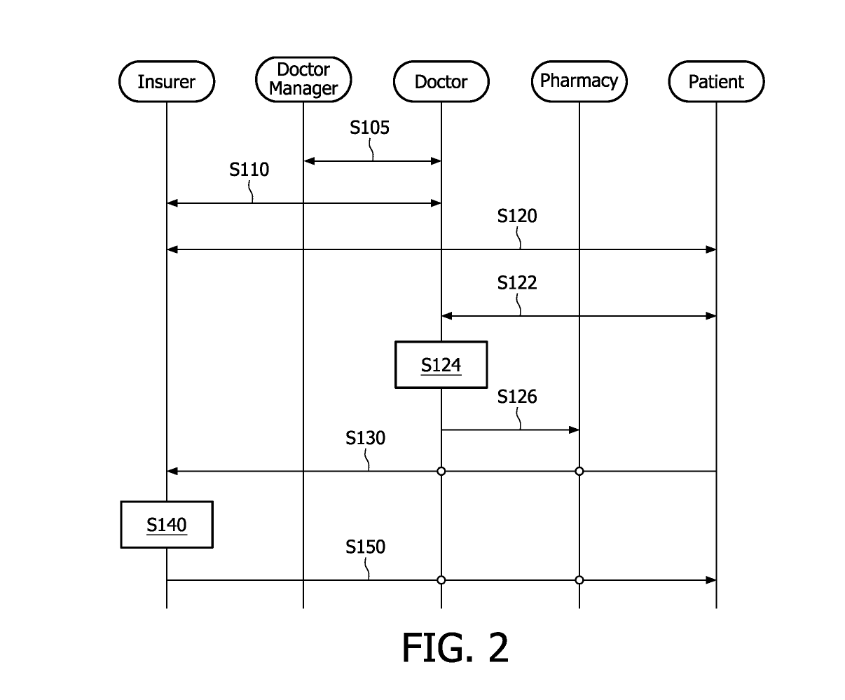

FIG. 2 schematically shows an embodiment of a method of authenticating electronic prescriptions according to the invention.

In step S105 of the process according to the invention, the doctor first sends the doctor manager a registration message, which indicates the doctor's identification, public key and a proof of knowing the doctor's private key. Optionally, the registration message includes the doctor's professional certificate.

The registration message from the doctor to the doctor manager can be expressed as:

Dr->DM:P_{DM}(ID_{Dr},Certificate,y_{Dr}),V₁=SK[(x_{Dr}):y_{Dr}=g^{x}^{_{Dr}}](m_{DM}) Msg[1]

wherein Dᵣ represents the doctor, DM represents the doctor manager, ID_{Dr} is the doctor's identification, y_{Dr} is the public key of the doctor, and certificate represents professional capability-related information regarding the doctor.

V₁ is a signature generated by the doctor on the basis of the doctor's private key x_{Dr} and a challenge message m_{DM} from the doctor manager. y_{Dr}=g^{x}^{_{Dr}} represents the relationship between the doctor's public key and private key that is held by the doctor as a secret. V₁ is generated on the basis of a signature function SK[•] and is a proof of knowing the doctor's private key x_{Dr} in zero-knowledge. The generation and verification of a signature has been described in detail in many prior-art documents, for example, in Ref. 1.

In the registration message from the doctor to the doctor manager, P_{DM} means encryption on the registration message with the doctor manager's public key, and the signature V₁ can be sent to the doctor manager in one or two messages depending on when the doctor acquires the challenge message from the doctor manager. For example, the doctor may acquire the challenge message from the doctor manager's electronic public board before registration and then the doctor can send the information element and the signature in one message. The doctor may also send the signature in an additional message after trying registration and receiving the challenge message from the doctor manager.

Once the doctor manager receives the signature, he can use the doctor's public key y_{Dr}, the challenge message m_{DM} and the signature V₁ to verify the doctor's real identification, e.g. whether or not the register knows the doctor's private key x_{Dr}. Details of the verification can be found in Ref 1.

When the verification holds, the doctor manager can further check the doctor's certificates and generates a pseudonym Y_{Dr} (a first pseudonym) for the doctor on the basis of the doctor's public key and the doctor manager's private key in accordance with Eq. [1], e.g., Y_{Dr}=y_{Dr}^{x}^{_{DM}}, wherein x_{DM} is the private key of the doctor manager.

The doctor manager stores the doctor's identification, public key and the first pseudonym of the doctor in his database and publishes the first pseudonym and the doctor manager's public key on his electronic public board in a shuffled way. The publication can be expressed as:

DM->PB_{DM}:Y_{Dr}=y_{Dr}^{x}^{_{DM}},y_{DM} Msg[2]

wherein Y_{Dr} is the doctor's first pseudonym and y_{DM} is the public key of the doctor manager, complying with:

y_{DM}=g^{x}^{_{DM}} [5]

The doctor looks up the doctor manager's electronic public board to check if there is a pseudonym that complies with:

Y_{Dr}=y_{DM}^{x}^{_{Dr}} [6]

If there is such a pseudonym, the doctor manager will download Y_{Dr} from the electronic public board and take it as its first pseudonym. Optionally, the doctor manager may send a publication notice to the doctor.

In step S110, the doctor sends the insurer a registration message, which comprises the doctor's first pseudonym, public key, a proof of knowing the doctor's private key, and optionally a registration key randomly generated by the doctor. The message from the doctor to the insurer can be expressed as:

Dr->I:P_{I}(Y_{Dr},R_{Dr}),V₂=SK[(x_{Dr}):Y_{Dr}=(y_{DM})^{x}^{_{Dr}}](m_{I}) Msg.[3]

wherein I represents the insurer, P_{I} means encryption on the message with the insurer's public key, and R_{Dr} is the registration key randomly generated by the doctor. V₂ is the doctor's signature based on the doctor's private key x_{Dr}, the doctor's first pseudonym Y_{Dr}, and a challenge message m_{I} from the insurer, while Y_{Dr}=(y_{DM})^{x}^{_{Dr}} represents the relationship between the doctor's first pseudonym Y_{Dr}, the doctor manager's public key y_{DM} and the doctor's private key x_{Dr}. V₂ is generated by using a signature function SK[•] and is a proof of knowing the doctor's private key x_{Dr} in zero-knowledge.

In the registration message from the doctor to the insurer, the information element P_{I} and the signature V₂ can be sent as one message at the same time if the challenge message from the insurer is already known before registration. Otherwise, the doctor can send the information element and the signature in two messages.

Once the insurer receives the signature, the insurer can use the doctor's first pseudonym Y_{Dr}, the doctor manager's public key y_{DM}, the challenge message m_{DM} and the signature V₁ to verify whether or not the register knows the doctor's private key x_{Dr}.

When the verification is positive, the insurer will check whether the doctor's first pseudonym Y_{Dr} does exist on the doctor manager's electronic public board, e.g. the doctor has registered at the doctor manager. If so, the insurer restores the doctor's first pseudonym Y_{Dr} and registration key R_{Dr} in the insurer's database. Here, the doctor's registration key R_{Dr} is the secret shared by the doctor and the insurer. Optionally, R_{Dr} can also be generated by the insurer and shared between the doctor and the insurer.

In step S120, a patient can register at the insurer by similarly using the process described in step S105. The registration message from the patient to the insurer can be expressed as:

P->I:P_{I}(ID_{P},Healthplan,y_{P}),V₃=SK[(x_{P}):y_{P}=g^{x}^{_{P}}](m_{I}) Msg.[4]

wherein P represents the patient, P_{I} means encryption on the message, ID_{P} is the patient's identity information, and Healthplan is an optional information element relevant to the agreement between the patient and the insurer, such as a health plan or a reimbursement scheme. Here, xₚ, yₚ and m_{I} are the patient's private key, public key and a challenge message from the insurer, respectively. The generation and verification of the signature V₃ is realized similarly as described above.

Once the insurer has received the registration from the patient and verified the patient's pseudonym, the insurer will generate a pseudonym Y_{P} (a second pseudonym) for the patient, and restore the doctor's identification ID_{P} and public key yₚ in the insurer's database with a link to the patient's health plan. The insurer publishes the patient's pseudonym and also the insurer's public key y_{I} on his electronic public board in a shuffled way. The publication can be expressed as:

I->PB_{I}:Y_{P}=y_{P}^{x}^{_{I}},y_{I} Msg.[5]

In this way, the patient can easily pick up the pseudonym by verifying if there is one pseudonym Y_{P} on the board that complies with the equation:

Y_{P}=(y_{I})^{x}^{_{P}} [7]

Optionally, the insurer can directly send the pseudonym Y_{P} to the patient. The patient then stores the pseudonym Y_{P} in his local storage, such as a smart card or USB disc and uses it as a transaction key when visiting a doctor, agreeing on a prescription and filling out the prescription.

In step S122, when a patient visits a doctor, the patients provides the doctor with his pseudonym Y_{P} as a transaction key to the doctor and a proof of knowing the patient's private key xₚ by means of a signature, which can be expressed as:

P->Dr:Y_{P},V₄=SK[(x_{P}):Y_{P}=(y_{I})^{x}^{_{P}}](TH∥m_{Dr}) Msg.[6]

wherein, m_{Dr} is a challenge message from the doctor and TH is a transaction header that contains, but is not limited to a transaction ID, date of commencement and expiration, insurance and health plan identifiers. (TH∥m_{Dr}) is a concatenation of the transaction header and the challenge message from the doctor.

The doctor first checks the existence of the pseudonym Y_{P} in the insurer's electronic public board. He then verifies the signature so as to make sure that the patient has registered a certain health plan at the insurer. The generation and verification of the signature is realized in the same way as described above. After diagnosis, the doctor prepares an electronic prescription for the patient.

In step S124, to sign up the electronic prescription, a transaction pseudonym Ŷ_{DR} is generated for the doctor on the basis of the first pseudonym Y_{Dr}, the registration key R_{Dr} shared with the insurer and a transaction key k, in accordance with Eq.[3] and Eq.[4].

The electronic prescription contains a set of information {e-prescription,Ve,V₅,V₆}, which can be expressed as follows:

e-prescription=P_{Ph}(Y_{P},Ŷ_{Dr},ep,TH) [8]

V₅=SK[(x_{Dr}):Ŷ_{Dr}=(g^{x}^{_{DM}}^{·k}^{ᵢ})^{x}^{_{Dr}}](TH,ep,Y_{P}) [9]

Ve=P_{I}(Y_{Dr},i,TH,ep,Y_{P}) [10]

V₆=SK[(x_{P}):Y_{P}=(y_{I})^{x}^{_{P}}](ep,TH) [11]

Here, ep is the electronic prescription pad, which includes a prescription ID, and a description of a medical drug. TH is a transaction header that contains, but is not limited to a transaction ID, date of commencement and expiration, and insurance and health plan identifiers.

V₅ is a signature of the doctor to prove who issued the electronic prescription and Ve is generated intentionally for the insurer so as to link anonymous doctors issuing different electronic prescriptions with the first pseudonym to the same doctor. V₆ is a signature of the patient to prove whom the electronic prescription is issued for and agreed by. Ve is a message encrypted for authentication with the insurer's public key.

In step S126, the doctor or the patient forwards the electronic prescription to a pharmacy. As in a realistic situation, the electronic prescription is most likely to be sent to the pharmacy, for the pharmacy is the entity to fill out the prescription and collect the amount due for payment.

In step S130, to validate the electronic prescription, the pharmacy sends an authentication request message with the electronic prescription and a transaction head TH₀ to the insurer. The original message sent to the insurer can be expressed as:

Ph->I:{V₅,V₆,Ve} Msg.[7]

It is advantageous that the message is sent to the insurer after the pharmacy has decrypted the electronic prescription.

In step S140, once the insurer receives the electronic prescription, the insurer authenticates the electronic prescription on the basis of verifying the doctor and the patient's registration. First, the insurer can retrieve the doctor's first pseudonym Y_{Dr} and the transaction number i from the electronic prescription. Furthermore, from the transaction number i and the registration key R_{Dr}, the insurer can calculate the transaction key kᵢ in accordance with Eq.[4]. Taking advantage of the unique mapping relationship between the registration key R_{Dr} and the first pseudonym Y_{Dr} the insurer can calculate the doctor's transaction pseudonym Ŷ_{DR} in accordance with Eq.[3].

After retrieving the doctor's transaction pseudonym Ŷ_{DR}, the insurer can use it to verify the signature V₅ in accordance with the method as described above and thus confirm the doctor's registration. If the verification holds, the insurer can be sure that a legally registered doctor issues the prescription.

Similarly, the insurer can also use the patient's pseudonym to verify the patient's signature V₆ and thus confirm the patient's authorization. If the verification holds, the insurer can be sure that the prescription is issued for a registered patient.

When both verifications of the doctor and the patient hold, the insurer will check the consistency between the prescription and the health plan of the patient as well as the doctor's history record.

This method enables the doctor to use a different transaction pseudonym to prepare each electronic prescription. However, the first pseudonym remains the same for generating each transaction pseudonym. The insurer can therefore link all prescriptions prepared by the same doctor to an identical first pseudonym, and can thus check the history record of the doctor without knowing his real identification.

After verification and checking, the insurer will send the pharmacy an acknowledgement of authentication including a signature V₇ and optionally a promise to pay the bill for the electronic prescription. The signature V₇ can be expressed as:

I->Ph:e-payment,V₇=S_{I}(ep,Y_{P},Ŷ_{D},TH) Msg.[8]

Based on the acknowledgement of authentication from the insurer, the pharmacy will fill out the drug prescription and collect the amount due for payment from the insurer at a later point of time.

Depending on different payment schemes of an electronic prescription system, the electronic prescription can of course also be sent to the insurer by the patient or the doctor. In such situations, the process of authentication is still substantially the same.

As the patient signs an electronic prescription by using his pseudonym, he can keep his privacy away from the pharmacy. Furthermore, as the same pseudonym is used for all electronic prescriptions issued for the patient, the pharmacy can still link all electronic prescriptions issued for the patient to the identical patient pseudonym and thus provide a possible way of checking any drug confliction prescribed by different doctors.

As the transaction pseudonym that the doctor has used for signing the prescription is generated in conformity with the doctor's first pseudonym, registration key and a transaction key, which is different for each electronic prescription issued by the doctor, the doctor can keep his privacy away from the pharmacy, the doctor manager and the insurer.

It should be noted that the electronic prescription can also be sent directly to the insurer for authentication. In such a situation, the content of the electronic prescription remains substantially the same as that sent by the pharmacy.

It should also be noted that, despite the reliable protection of the doctor and the patient, a doctor or patient's anonymity is revocable in certain circumstances, such as in a fraud investigation. This can be easily achieved in the invention by coordination between the responsible judge, the insurer and the doctor manager.

For example, to investigate a doctor issuing the electronic prescription in question, the judge submits an investigation request to the insurer with the doctor's signature V₅ and Vₑ. The insurer can prove conformity of Y_{Dr} and Ŷ_{Dr} with R_{Dr} and i, and then the doctor manager can prove conformity between the first pseudonym Y_{Dr} and the doctor's public key y_{Dr}. The doctor manager can reveal the real identity of the doctor from his database without leaking the doctor manager's private key.

The above method of authenticating an electronic prescription as provided in the present invention can be implemented in software or hardware, or in a combination of both.

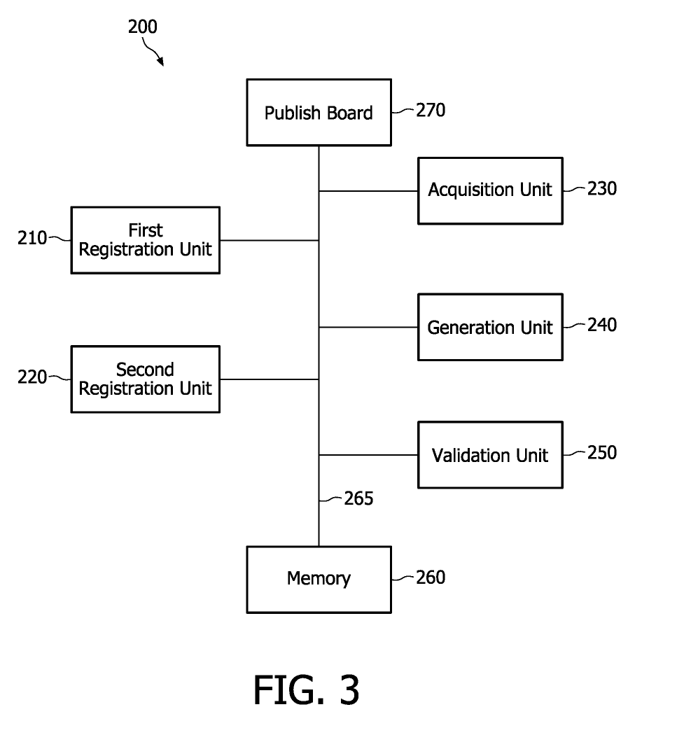

FIG. 3 is a block diagram showing an embodiment of an authentication system 200 according to the invention. The authentication system 200 comprises:

an acquisition unit 230 for acquiring an electronic prescription for authentication, the electronic prescription comprising a transaction number, a first pseudonym, and a signature of a first participant using a transaction pseudonym, the first pseudonym indicating the first participant's registration at a first privacy officer;

a generation unit 240 for generating the transaction pseudonym based on the first pseudonym, the transaction number and a registration key corresponding to the first pseudonym and being shared between the first participant and a second privacy officer; and

a validation unit 250 for verifying the first participant's registration at the second privacy officer and the authenticity of the signature based on the registration key and the transaction pseudonym.

It is advantageous that the validation unit 250 of the authentication system 200 is further arranged to check the first participant's history record by linking all electronic prescriptions signed by the first participant to the first pseudonym.

Optionally, the authentication system 200 further comprises a first registration unit 210 for registering the first participant at the second privacy officer so that the first participant's identity can be uniquely determined by mapping the registration key shared between the first participant and the second privacy officer to the first pseudonym.

The first registration unit may comprise a receiving unit for receiving, from the first participant, a registration message comprising the first pseudonym indicating registration at the first privacy officer and a proof of knowing the private key of the first participant; a verifying unit for verifying the first participant's registration at the first privacy officer by checking the existence of the first pseudonym at the first privacy officer; and a mapping unit for mapping the first pseudonym to the registration key shared between the first participant and the second privacy officer.

Furthermore, the system 200 comprises a second registration unit 220 for registering the second participant at the second privacy officer so that the second participant's identity can be uniquely determined by a second pseudonym.

It is advantageous that the electronic prescription further comprises the second pseudonym and a signature of the second participant using the second pseudonym, while the validation unit 250 is further arranged to verify the second participant's registration and signature based on the second pseudonym and to check the second participant's history record by linking all electronic prescriptions signed by the second participant to the second pseudonym.

Optionally, the authentication system 200 further comprises a memory 260 for storing registration information and history information related to the registered participants, an electronic public board 270 for publishing the second pseudonym and public key of the participants and privacy officers, and a bus 265 for connecting all elements in the authentication system.

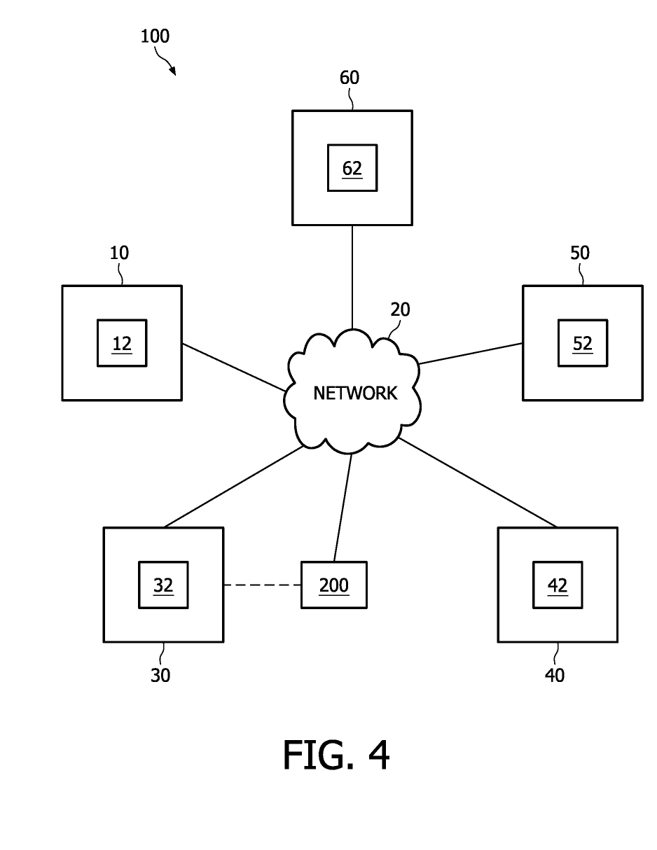

FIG. 4 is a block diagram showing an embodiment of a prescription processing system 100 including an authentication system 200 according to the invention. The prescription processing system 100 further includes a doctor manager agent (a first privacy officer agent) 10 maintaining presence on the Internet or other similar communication network 20 via a server 12 or otherwise; an insurer agent (a second privacy officer agent) 30 maintaining presence on the communication network 30 via a server 32; a doctor agent (a prescription originator agent) 40 gaining access to the communication network by using a computer 42 with an appropriate input device; and a patient agent (a prescription recipient) 50 gaining access to the communication network 20 by using a computer or smart card 52, and optionally a pharmacy agent (a prescription drug provider) 60 maintaining presence on the communication network via a computer 62 or the like. It is advantageous that the insurer agent 30 administers the authentication system 200, which is most likely a part of the insurer agent 30.

Of course, system 100 is preferably administered to a plurality of similarly situated doctors 40, patients 50 and pharmacies 60. However, for the sake of simplicity in this description, only one of each is shown in FIG. 4. Moreover, whereas this description refers to the Internet 20, it will be evident to those skilled in the art that other communication networks, local or wide-area computer networks, cellular networks, hardwired networks, etc. may also be employed as means for communicating data and/or information between participants. Likewise, various terminals or other desired interfacing hardware optionally replace the computers and servers as appropriate for a given network. Additionally, while not explicitly proposed in every instance described herein, it is to be appreciated that the security of the system 100 is further enhanced by optionally encrypting, with known encryption techniques, any or all of the communications relayed or otherwise transmitted over the Internet 20.

It should be noted that the above-mentioned embodiments illustrate rather than limit the invention and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. Use of the indefinite article “a” or “an” preceding an element does not exclude the presence of a plurality of such elements. The invention can be implemented by means of hardware comprising several distinct elements and by means of a suitably programmed computer. In the system claims enumerating several units, several of these units can be embodied by one and the same item of hardware or software. Use of the words “first”, “second” and “third”, etc. does not indicate any ordering. These words are to be interpreted as names.

1. A system for authenticating electronic prescriptions, the system comprising:
an acquisition unit for acquiring an electronic prescription for authentication, the electronic prescription comprising a transaction number, a first pseudonym, and a signature of a first participant using a transaction pseudonym, the first pseudonym indicating the first participant's registration at a first privacy officer;
a generation unit for generating the transaction pseudonym based on the first pseudonym, the transaction number and a registration key corresponding to the first pseudonym and being shared between the first participant and a second privacy officer; and
a validation unit for verifying the first participant's registration at the second privacy officer and the authenticity of the signature based on the registration key and the transaction pseudonym.

2. The system as claimed in claim 1, wherein the generation unit is arranged to generate the transaction pseudonym in accordance with the following equation:
Ŷ_{DR}=(Y_{Dr})^{k}^{ᵢ},kᵢ=h(R_{Dr}⊕kᵢ₋₁),k₀=(R_{Dr}∥Y_{Dr})
wherein Ŷ_{DR} is the transaction pseudonym, i is the transaction number related to the electronic prescription, kᵢ is a transaction key as defined, and R_{Dr} is the registration key shared between the second privacy officer and the first participant, wherein h(•) is a cryptographic hash function, and k₀ is the concatenation of the registration key R_{Dr} and the first pseudonym Y_{Dr}.

3. The system as claimed in claim 1, wherein the validation unit is further arranged to check the first participant's history record by linking all electronic prescriptions signed by the first participant to the first pseudonym.

4. The system as claimed in claim 1, further comprising a first registration unit for registering the first participant at the second privacy officer so that the first participant's identity can be uniquely determined by mapping the registration key shared between the first participant and the second privacy officer to the first pseudonym.

5. The system as claimed in claim 4, wherein the first registration unit comprises:
a receiving unit for receiving, from the first participant, a registration message comprising the first pseudonym indicating registration at the first privacy officer and a proof of knowing the private key of the first participant,
a verifying unit for verifying the first participant's registration at the first privacy officer by checking the existence of the first pseudonym at the first privacy officer; and
a mapping unit for mapping the first pseudonym to the registration key shared between the first participant and the second privacy officer.

6. The system as claimed in claim 1, further comprising a second registration unit for registering a second participant at the second privacy officer so that the second participant's identity can be uniquely determined by a second pseudonym.

7. The system as claimed in claim 6, wherein the electronic prescription further comprises a second pseudonym and a signature of a second participant using the second pseudonym, and the validation unit is further arranged to verify the second participant's registration at the second privacy officer and the authenticity of the signature based on the second pseudonym and to check the history record of the second participant by linking all electronic prescriptions signed by the second participant to the second pseudonym.

8. The system as claimed in claim 1, wherein the first participant, a second participant, a first privacy officer and a second privacy officer are a doctor agent, a patient agent, a doctor manager agent and an insurer agent, respectively.

9. A method of authenticating electronic prescriptions, the method comprising the steps of:
acquiring an electronic prescription for authentication, the electronic prescription comprising a transaction number, a first pseudonym indicating a first participant's registration at a first privacy officer, and a signature of the first participant using a transaction pseudonym;
generating the transaction pseudonym based on the first pseudonym, the transaction number and a registration key corresponding to the first pseudonym and being shared between the first participant and a second privacy officer; and
verifying the authenticity of the registration and signature of the first participant on the basis of the registration key and the transaction pseudonym.

10. The method as claimed in claim 9, wherein the transaction pseudonym is generated in accordance with the following equation:
Ŷ_{DR}=(Y_{Dr})^{k}^{ᵢ},kᵢ=h(R_{Dr}⊕kᵢ₋₁),k₀=(R_{Dr}∥Y_{Dr})
wherein Ŷ_{DR} is the transaction pseudonym, i is the transaction number related to the electronic prescription, kᵢ is a transaction key as defined, and R_{Dr} is the registration key shared between the second privacy officer and the first participant, wherein h(•) is a cryptographic hash function, and k₀ is the concatenation of the registration key R_{Dr} and the first pseudonym Y_{Dr}.

11. The method as claimed in claim 9, further comprising a step of checking the first participant's history record by linking all electronic prescriptions signed by the first participant to the first pseudonym.

12. The method as claimed in claim 9, further comprising a step of registering the first participant at the second privacy officer so that the first participant's identity can be uniquely determined by mapping the registration key shared between the first participant and the second privacy officer to the first pseudonym.

13. The method as claimed in claim 9, further comprising a step of registering a second participant at the second privacy officer so that the second participant's identity can be uniquely determined by a second pseudonym.

14. The method as claimed in claim 13, wherein the electronic prescription further comprises the second pseudonym and a signature of the second participant using the second pseudonym, and the method further comprises a step of verifying the second participant's registration and signature based on the second pseudonym and of checking the second participant's history record by linking all electronic prescriptions signed by the second participant to the second pseudonym.

15. The method as claimed in claim 9, wherein the first participant, a second participant, a first privacy officer and a second privacy officer are a doctor agent, a patient agent, a doctor manager agent and an insurer agent, respectively.

16. A computer program product to be loaded by a computer arrangement, comprising instructions for authenticating electronic prescriptions, the computer arrangement comprising a processing unit and a memory, the computer program product, after being loaded, enabling said processing unit to carry out the following tasks:
acquiring an electronic prescription for authentication, the electronic prescription comprising at least a transaction number, a first pseudonym, and a signature of a first participant using a transaction pseudonym, the first pseudonym indicating the first participant's registration at a first privacy officer;
generating the transaction pseudonym based on the first pseudonym, the transaction number and a registration key corresponding to the first pseudonym and being shared between the first participant and a second privacy officer; and
verifying the authenticity of the registration and signature of the first participant on the basis of the registration key and the transaction pseudonym.

17. A method of generating a transaction pseudonym for secure authentication, the method comprising the steps of:
registering a participant at a first privacy officer so that the participant's identity can be uniquely defined and determined by a first pseudonym;
registering the participant at a second privacy officer so that the participant's identity can be uniquely determined by mapping a registration key shared between the second privacy officer and the participant to the first pseudonym; and
generating a transaction pseudonym for the participant on the basis of the first pseudonym, the registration key and a transaction number related to a transaction.

18. The method as claimed in claim 17, wherein the first pseudonym is generated in accordance with the following equation:
Y_{Dr}=y_{Dr}^{x}^{_{DM}},y_{Dr}=g^{x}^{_{Dr}} mod p
wherein Y_{Dr} is the first pseudonym, x_{DM} is the first privacy officer's private key, y_{Dr} and x_{Dr} are the participant's public key and private key, respectively, p is a large prime number and g is a generator of the group of p with order q, the private key x_{Dr}ε{1, . . . , q−1}, and q is a large prime number complying with q/(p−1).

19. The method as claimed in claim 17, wherein the transaction pseudonym is generated in accordance with the following equation:
Ŷ_{DR}=(Y_{Dr})^{k}^{ᵢ},kᵢ=h(R_{Dr}⊕kᵢ₋₁),k₀=(R_{Dr}∥Y_{Dr)}
wherein Ŷ_{DR} is the transaction pseudonym, i is the transaction number related to the electronic prescription, kᵢ is a transaction key as defined, and R_{Dr} is the registration key shared between the second privacy officer and the first participant, wherein h(•) is a cryptographic hash function, and k₀ is the concatenation of the registration key R_{Dr} and the first pseudonym Y_{Dr}.
